(19) United States
(12) Patent Application Publication
(10) Pub. No.: US 2012/0308386 A1
(43) Pub. Date: Dec. 6, 2012

(54) Chain Drive Train for a Wind Turbine

(75) Inventors: Zbigniew Piech, Cheshire, CT (US); Richard N. Fargo, Plainville, CT (US); Richard A. Himmelmann, Rockford, IL (US)

(73) Assignee: Clipper Windpower, LLC, Carpinteria, CA (US)

(21) Appl. No.: 13/279,738

(22) Filed: Oct. 24, 2011

Related U.S. Application Data
(60) Provisional application No. 61/491,843, filed on May 31, 2011.

(51) Int. Cl. F03D 11/02

(52) U.S. Cl. 416/170 R

(57) ABSTRACT

A distributed chain drive train for a wind turbine is disclosed. The chain drive train may include a first stage chain drive adapted to receive mechanical energy from a main shaft of a wind turbine and a second stage chain drive adapted to receive rotational energy from the first stage chain drive and transmitting the rotational energy to one or more generators of the wind turbine. The chain drives are resilient to structural deflections that may misalign the sprockets and chains, resulting in a long lasting system.

### CROSS-REFERENCE TO RELATED APPLICATION

This application is a Non-Provisional Patent Application claiming priority under 35 U.S.C. §119(e) to U.S. Provisional Patent Application Ser. No. 61/491,843 filed on May 31, 2011, the entirety of which is incorporated by reference herein.

### FIELD OF THE DISCLOSURE

The present disclosure generally relates to wind turbines and, more particularly, relates to drive trains for transferring energy from a main shaft to one or more generators of wind turbines.

### BACKGROUND OF THE DISCLOSURE

A utility-scale wind turbine typically includes a set of two or three large rotor blades mounted to a hub. The rotor blades and the hub together are referred to as the rotor. The rotor blades aerodynamically interact with the wind and create lift, which is then translated into a driving torque by the rotor. The rotor is attached to and drives a main shaft, which in turn is operatively connected via a drive train to a generator or a set of generators that produce electric power.

Many types of drive trains are known for connecting the main shaft to the generator(s). One type of drive train uses various designs and types of speed increasing gearboxes to connect the main shaft to the generator(s). Typically, the gearboxes include one or more stages of gears and a large housing, wherein the stages increase the rotor speed to a speed that is more efficient, or more economical, for driving the generator(s). While effective, large forces translated through the gearbox can deflect the gearbox housing and components therein and displace the large gears an appreciable amount so that the alignment of meshing gear teeth can suffer. When operating with misaligned gear teeth, the meshing teeth can be damaged, resulting in a reduced lifespan. The large size of these gearboxes and the extreme loads handled by them make them even more susceptible to deflections and resultant premature wear and damage. Furthermore, maintenance and/or replacement of parts of damaged gearboxes may not only be difficult and expensive, it may require entire gearboxes to be lifted down from the wind turbine.

Some other drive trains are known as direct drive trains, wherein instead of a gearbox, a mechanical coupling is provided between the main shaft and a generator input shaft often in-line therewith or, alternatively, the generator is mounted as an integral part of the rotor hub assembly. US Patent Publication No. 2009/0026771, in the name of Bevington, is one example of such a direct drive. Direct drive trains are not only heavier than gearbox drive trains, they also utilize a larger volume of rare earth elements, thereby increasing the cost of the overall drive train. The difficulty of maintenance and/or replacement of parts in direct drive trains is also compounded in comparison with gearbox drive trains due to the size of such drive trains.

Accordingly, it would be beneficial if an improved wind turbine drive train that is not as susceptible to damage from deflections in the gearbox and resultant misalignments of components is developed. It would additionally be beneficial if such a drive train were easily serviceable, did not weigh as much as traditional gearboxes and direct drive trains and were not as expensive to install, operate and maintain.

### SUMMARY OF THE DISCLOSURE

In accordance with one aspect of the present disclosure, a wind turbine is disclosed. The wind turbine may include a hub, a plurality of blades radially extending from the hub and a main shaft rotating with the hub. The wind turbine may further include a drive sprocket mounted onto the main shaft and a plurality of driven sprockets symmetrically arranged around the main shaft. The wind turbine may also include at least one drive strand connecting the drive sprocket to the plurality of driven sprockets and at least one generator operatively connected to and driven by the plurality of driven sprockets.

In accordance with another aspect of the present disclosure, a wind turbine is disclosed. The wind turbine may include a hub, a plurality of blades radially extending from the hub and a main shaft rotating with the hub. The wind turbine may also include a first stage drive train having a first stage drive sprocket operatively connected to the main shaft, at least one first stage driven sprocket, and at least one first stage strand trained around the first stage drive sprocket and the at least one first stage driven sprocket, the first stage drive train increasing speed relative to the main shaft, while reducing torque. The wind turbine may further include a second stage drive train operatively connected to the first stage drive train, the second stage drive train having at least one second stage drive sprocket operatively connected to the at least one first stage driven sprocket, the second stage drive train further having at least one second stage driven sprocket, and at least one second stage strand trained around the at least one second stage drive sprocket and the at least one second stage driven sprocket, the second stage drive train increasing speed relative to the first stage drive train, while further reducing torque.

In accordance with yet another aspect of the present disclosure, a wind turbine is disclosed. The wind turbine may include a hub, a plurality of blades radially extending from the hub and a main shaft rotating with the hub. The wind turbine may further include a drive train comprising a first stage drive train having a first stage drive sprocket operatively mounted on the main shaft, the first stage drive sprocket having a plurality of drive sprocket segments with each of the plurality of drive sprocket segments driving one of a plurality of first stage driven sprockets through a first stage strand; and (b) a second stage drive train connected to the first stage drive train, the second stage drive train having a plurality of second stage drive sprockets, each of the plurality of second stage drive sprockets driven by one of the plurality of first stage driven sprockets and further driving one of a plurality of second stage driven sprockets through a second stage strand.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is a schematic illustration of a housing of an exemplary drive train;

FIG. 3 is a schematic illustration of the drive train of FIG. 2 with the housing removed;

FIG. 4 is a perspective view of a sprocket employed within the exemplary drive train of FIG. 3;

FIG. 5 is a perspective view of another sprocket employed within the exemplary drive train of FIG. 3; and

FIGS. 6-10 are schematic illustrations showing maintenance of the drive train of FIG. 2, in accordance with at least some embodiments of the present disclosure;

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

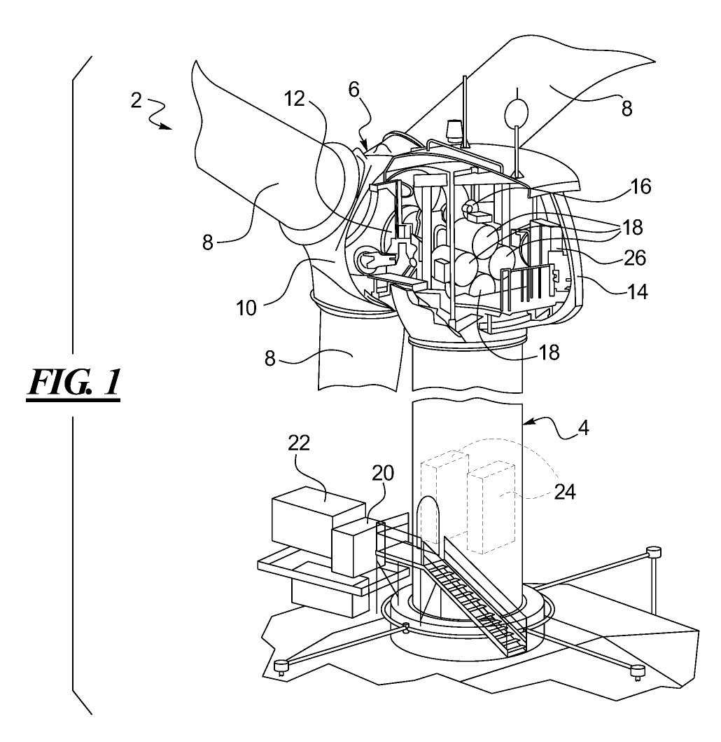

Referring to FIG. 1, an exemplary wind turbine 2 is shown, in accordance with at least some embodiments of the present disclosure. While all the components of the wind turbine have not been shown and/or described, a typical wind turbine may include a tower section 4 and a rotor 6. The rotor 6 may include a plurality of blades 8 connected to a hub 10. The blades 8 may rotate with wind energy and the rotor 6 may transfer that energy to a main shaft 12 situated within a nacelle 14. The nacelle 14 may additionally include a drive train 16, which may connect the main shaft 12 on one end to one or more generators 18 on the other end. The generators 18 may generate power, which may be transmitted through the tower section 4 to a power distribution panel (PDP) 20 and a pad mount transformer (PMT) 22 for transmission to a grid (not shown). Specifically, power from the generators 18 may be transmitted to inverters/converters situated within one or more generator control units (GCU) 24 positioned within the tower section 4, which in turn may transmit that power to the PDP 20 and the PMT 22. The GCUs 24 and other components within the wind turbine 2 may be operated under control by a turbine control unit (TCU) 26 situated within the nacelle 14.

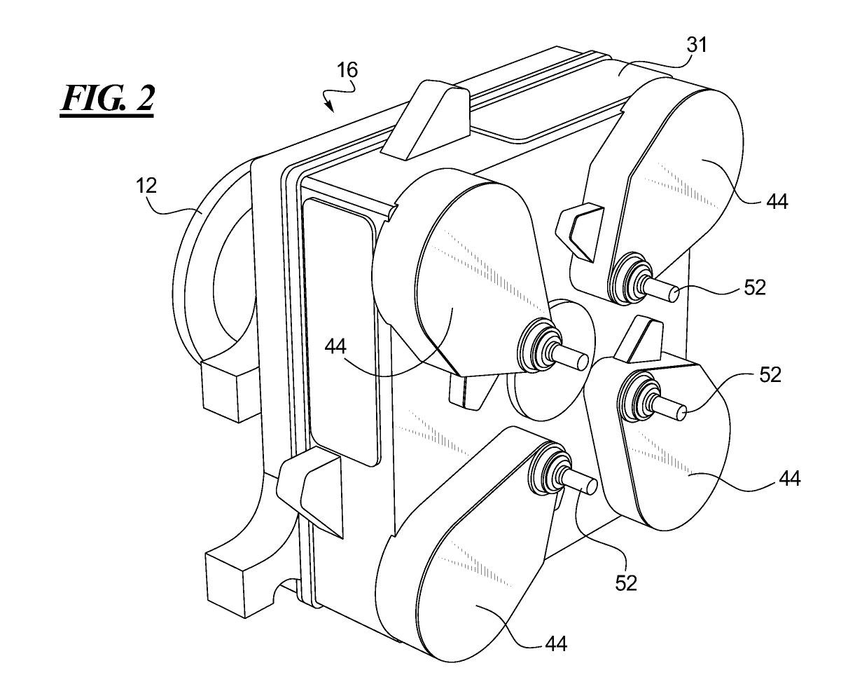

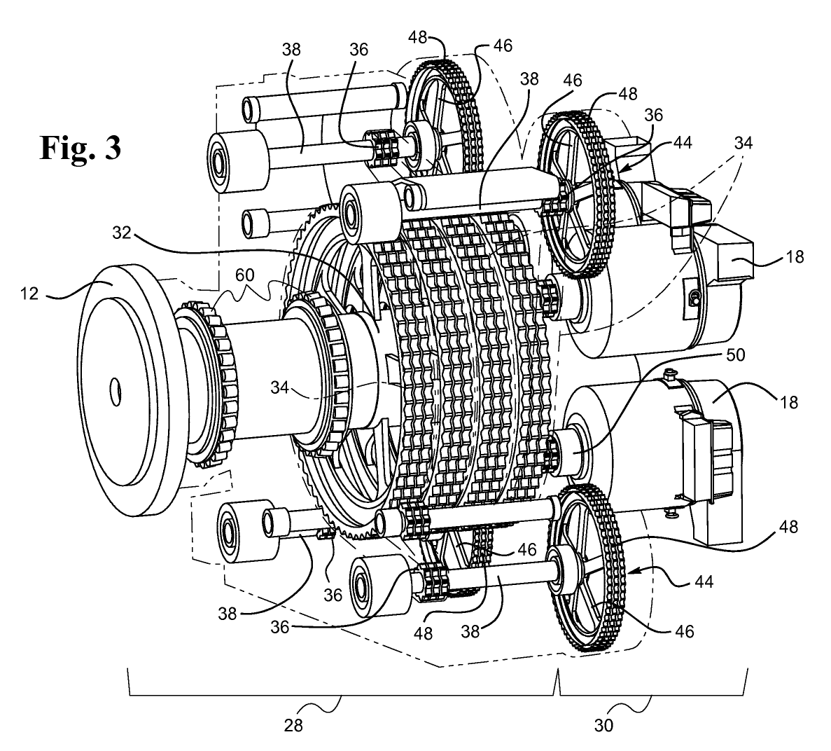

Referring now to FIGS. 2 and 3, a schematic illustration of the drive train 16 is shown, in accordance with at least some embodiments of the present disclosure. As shown in FIG. 3, the drive train 16 may include a first stage drive train and a second stage drive train. In at least some embodiments, each of the first and the second stage drive trains may be a chain drive train having a first stage chain drive (also referred to herein as a first stage drive chain) 28 connected to the main shaft 12 and the first stage leading to a second stage chain drive (also referred to herein as a second stage drive chain) 30 connected to the generators 18, both stages being discussed in greater detail below. Both, the first stage chain drive 28 and the second stage chain drive 30 may be enclosed within a housing 31, as shown in FIG. 2 although this need not always be the case. As will also be discussed below, the drive train 16 need not always include two chain drive stages (the first stage chain drive 28 and the second stage chain drive 30), as aforementioned. Rather, in at least some embodiments, a single stage of a chain drive or possibly even greater than two stages of the chain drive may be employed. Furthermore, one or both of the drive train stages may be belt drive stages or a combination of the chain drive and the belt drive.

Referring now specifically to FIG. 3, the first stage chain drive 28 may include a first stage drive sprocket 32 that may be driven by the main shaft 12, which in turn may be driven by the rotation of the blades 8. The first stage drive sprocket 32 may engage a plurality of chain strands 34 and each of the plurality of chain strands may be trained around to further drive one of a first stage driven sprocket 36. If a belt drive is desired instead of a chain drive, belt strands may be substituted for the chain strands 34, and the belt strands may be substituted in any instance where the chain strands are described in this disclosure, as will be understood by those of ordinary skill in this art. In the claims that are appended hereto “strand” may refer to any appropriate type of a chain strand or any appropriate type of a belt strand. Furthermore, notwithstanding the fact that in the present embodiment, each of the plurality of chain strands 34 individually drives a single first stage driven sprocket 36, in at least some embodiments, a single long chain may be employed in lieu of the plurality of chain strands to drive all of the first stage driven sprockets. Furthermore, in at least some embodiments, each of the first stage driven sprockets 36 may be smaller in size compared to the first stage drive sprocket 32. Each of the first stage driven sprockets 36 may in turn drive an intermediate speed shaft 38, which may be connected to the second stage chain drive 30, as described further below. By virtue of providing the first stage drive sprocket 32 engaging the plurality of chain strands 34 and each of the plurality of chain strands driving one of the first stage driven sprockets 36, torque from the rotor 6 may be split and distributed into multiple pathways. Splitting torque into multiple pathways at the first stage provides several advantages, such as, reducing the amount of torque experienced by each of the downstream drive train components, such as, the intermediate speed shafts 38, which results in smaller size and less expensive downstream drive train components.

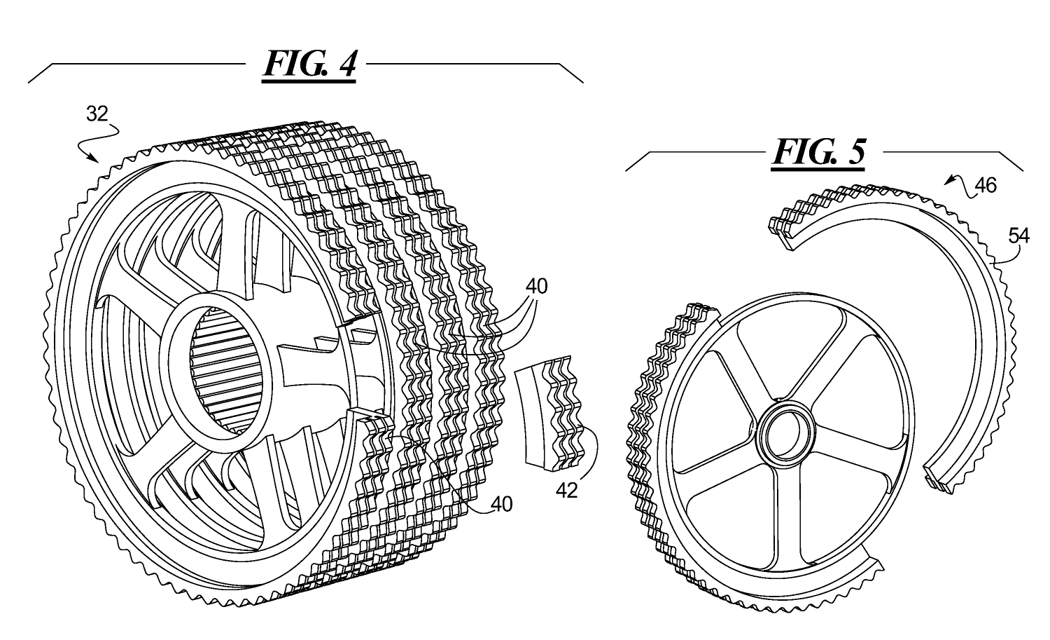

In at least some embodiments, the first stage drive sprocket 32, as shown in greater detail in FIG. 4, may be a segmented sprocket mounted onto the main shaft 12. Depending upon the number of the multiple pathways to split the torque into, the first stage drive sprocket may have multiple segments. For example, in at least some embodiments and, as shown, the first stage drive sprocket 32 may have four segments 40 for splitting the torque into four different pathways and each of the four segments may engage one of the plurality of chain strands (also referred to herein as low speed chain strands) 34 and each of the plurality of chain strands may drive one of the first stage driven sprockets 36. Furthermore, each of the four segments 40 may be constructed, in at least some embodiments, of a plurality of smaller segments 42 connected together. By virtue of providing the smaller segments 42 and constructing the four segments 40 from a plurality of the smaller segments, replacement or servicing of any one of the segments 40 may be easily facilitated. For example, only the defective one of the smaller segments 42 may be removed for servicing and replacement instead of removing the entire segment 40. Thus, for splitting the torque into four pathways, four of the segments 40 (and each made of a plurality of the smaller segments 42) of the first stage drive sprocket 32 engaging four of the plurality of chain strands 34 and four of the first stage driven sprockets 36 may be employed. Each of the first stage driven sprockets 36 may be mounted symmetrically about the main shaft 12 to further facilitate splitting of the torque from the rotor 6 into the four separate pathways, described above.

It will be understood that although in the present embodiment, the torque has been split and distributed into four pathways, this is merely exemplary and may depend upon several factors. For example, in at least some embodiments, the number of torque pathways may depend upon the number of generators 18 employed, such that for four generators as shown, four torque pathways may be employed. In other embodiments, the number of torque pathways may depend upon the size and capabilities of each of the components, such as, the first stage drive sprocket 32, the plurality of chain strands 34, each of the first stage driven sprockets 36 and the components of the second stage 30. In alternate embodiments, other parameters may be employed for determining the number of torque pathways.

Accordingly, the drive train 16 may be termed a distributed torque drive train that divides and reduces the torque output from the main shaft 12 into multiple path ways by way of the first stage drive sprocket 32 and the four of the first stage driven sprockets 36. In other embodiments, the number of the segments 40 in the first stage drive sprocket 32 and the number of the first stage driven sprockets 36 may vary to greater than four or possibly even less than four depending upon the torque split desired. By virtue of positioning the first stage driven sprockets 36 (and the four intermediate speed shafts 38) symmetrically about the rotational axis of the main shaft 12, at least some of the loads on the main shaft may be balanced out. “Symmetrically” in this context means an arrangement where the tension loads from the chain strands 34 are balanced and somewhat cancel one another out. By splitting the torque equally into four paths, and by arranging the first stage driven sprockets 36 symmetrically around the main shaft 12, the tension forces that the chain strands 34 exert on the segments 40 and in turn on the main shaft 12 somewhat cancel one another out, thereby resulting in a reduction of the overall forces on the main shaft 12 that must be reacted by main shaft bearings 60. Reducing and balancing forces on the main shaft bearings 60 is important in ensuring the longevity of the drive train design and/or in reducing the cost of those bearings.

The size, shape and weight of each of the first stage drive sprocket 32, the plurality of chain strands 34 and each of the first stage driven sprockets 36 may vary depending upon the size and power of the rotor 6. Thus, in at least some embodiments, for the rotor 6 rotating at 13.5 rotations per minute (13.5 rpm) and generating 2.78 Mega Watts (2.78 MW) of energy, the first stage drive sprocket 32 may be a 2.47 meter (972.44 inches) diameter segmented sprocket and having 102×0.08 meter (3 inches) pitch teeth. In addition, each of the smaller segments 42 of the first stage drive sprocket 32 may be a seventy four pound mass segment (74 lbm). Relatedly, each of the plurality of chain strands 34 may be a 2031 kilonewtons (2031 kN) simplex or duplex 240 standard chain having three strands and four paths. In at least some embodiments, one or more of the plurality of chain strands 34 may be roller chains, silent chains, high efficiency chains, toothed cables, toothed belts, V-belts or a combination thereof. Each of the first stage driven sprockets 36 in turn may be a 0.27 meter (10.63 inches) diameter sprocket having 11×0.08 meters (3 inches) pitch teeth and a 9.31:1 gear ratio. In other embodiments, one or more of the parameters of the first stage drive sprocket 32, the plurality of chain strands 34 and the first stage driven sprockets 36 may vary from those described above. Various idlers and other components, although not described, may also be included to ensure proper tensioning of the plurality of chain strands 34 and proper contact of the plurality of chain strands with the teeth of the first stage drive sprocket 32 and the first stage driven sprockets 36.

With respect to the second stage chain drive 30, in at least some embodiments, it may include a set of second stage chain drives, each of which may be connected to and driven by one of the intermediate speed shafts 38. Specifically, each of the second stage chain drives may include a second stage drive sprocket 46 driving a second stage chain or a high speed chain 48, which may be trained around a second stage driven sprocket 50 to drive a high speed shaft 52 connected to the generators 18. Thus, each of the plurality of chain strands 34 may drive each of the first stage driven sprockets 36, which in turn may drive each of the intermediate speed shafts 38, which may further drive each of the second stage drive sprockets 46 and the high speed chains 48 to drive the second stage driven sprockets 50 (See FIG. 6) and the high speed shafts 52 (See FIGS. 2 and 6) to drive the generators 18.

Accordingly, for splitting the torque into four torque pathways and for driving four of the generators 18, four of the second stage drive sprockets 46, four of the high speed chains 48, four of the second stage driven sprockets 50 and four of the high speed shafts 52 may be employed. Similar to the intermediate speed shafts 38, the high speed shafts 52 and the generators 18 may be oriented symmetrically around the central axis of the main shaft 12. In at least some embodiments, the high speed shafts 52 and the generators 18 may be oriented asymmetrically about the main shaft 12 as well.

Notwithstanding the fact that in the present embodiment, four of the generators 18 have been employed, in at least some other embodiments, the number of generators may vary depending upon the number of first stage driven and the second stage drive sprockets 36 and 46, respectively. In at least some other embodiments, a single generator connected to all of the second stage drive sprockets 46 (or possibly even directly connected to the first stage driven sprockets 36 in case of a single stage chain drive) may also be employed. In yet other embodiments, more than one of the generators 18 connected to each of the second stage drive sprockets 46 (or the first stage driven sprockets 36) or alternatively, one generator connected to more than one of the second stage drive sprockets (or the first stage driven sprockets) may be employed.

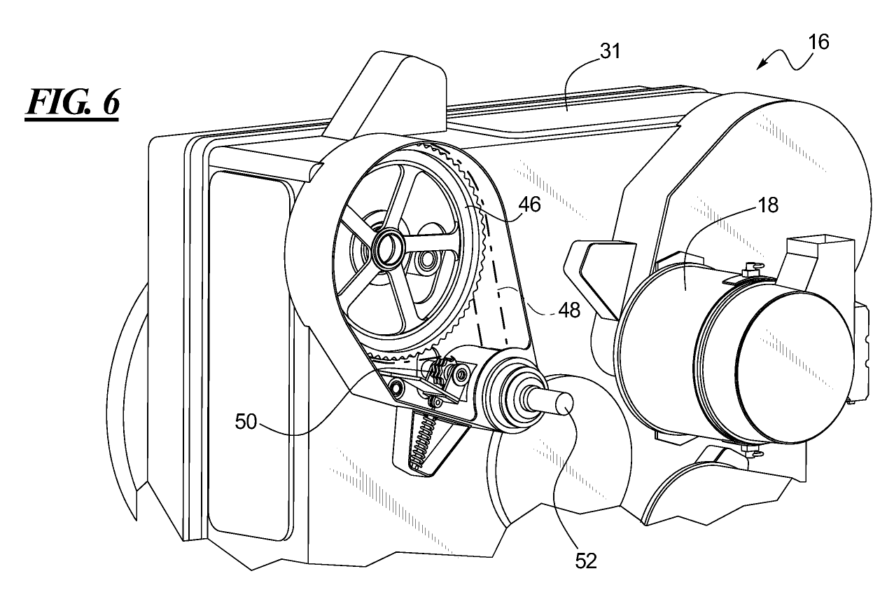

Also similar to the first stage drive sprocket 32, the second stage drive sprockets 46 may also be segmented sprockets, as shown in FIG. 5, having segments 54 for ease of serviceability of those sprockets. In at least some embodiments, each of the second stage drive sprockets 46 may be a 1.22 meter (48.03 inches) diameter sprocket rotating at 145 rotations per minute and having 86×0.04 meters (1.75 inches) pitch teeth with each of the segments 54 being a 120 lbm segment. Relatedly, each of the second stage driven sprockets 50 may be a 0.16 meter (6.3 inches) diameter sprocket rotating at 1133 rotations per minute and having 11×0.04 meters (1.75 inches) pitch teeth. Notwithstanding the fact that only the first stage drive sprocket 32 and the second stage drive sprockets 46 have been shown and described as being segmented sprockets, in at least some embodiments, each of the first stage driven sprockets 36, as well as the second stage driven sprockets 50 may be segmented sprockets. Similarly, in at least some embodiments, the first stage drive sprocket 32 and the second stage drive sprockets 46 need not be segmented sprockets, but rather may be other types of sprockets that may be suitable for using within the wind turbine 2. Furthermore, the high speed chain 48 may be a 647 kN simplex or duplex 140 standard chain having three strands and four paths. In other embodiments, other types of chains, cables or belts as mentioned above with respect to the plurality of chain strands 34 may be employed as well.

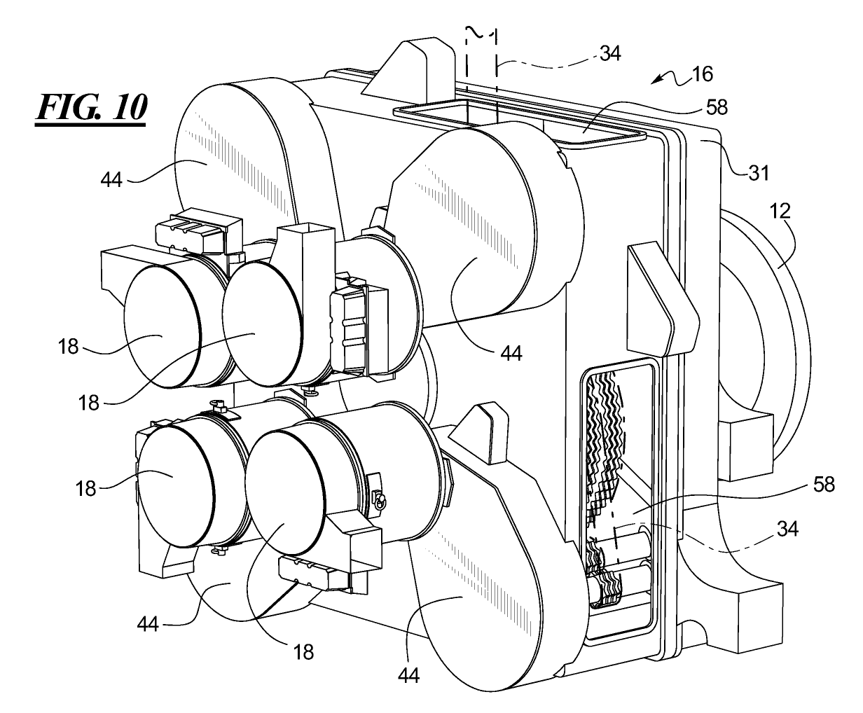

Referring now to FIGS. 6-10, various schematic illustrations showing maintenance features of the first stage chain drive 28 and the second stage chain drive 30 are shown, in accordance with at least some embodiments of the present disclosure. Specifically, FIGS. 6-9 show servicing of one of the second stage chain drive 30, while FIG. 10 shows servicing of the first stage chain drive 28. Referring now particularly to FIGS. 6-9, in order to service any component of the second stage chain drive 30, a cover 44 of the specific second stage chain drive to be serviced may be removed (e.g., by unbolting any bolts), as shown in FIG. 6, thereby exposing the second stage drive sprocket 46, the high speed chain 48, the second stage driven sprocket 50 and the high speed shaft 52 therein. It will be understood that the generator 18 connected to the specific second stage chain drive 30 that is being serviced is removed before the cover 44 may be removed for exposing the parts therein.

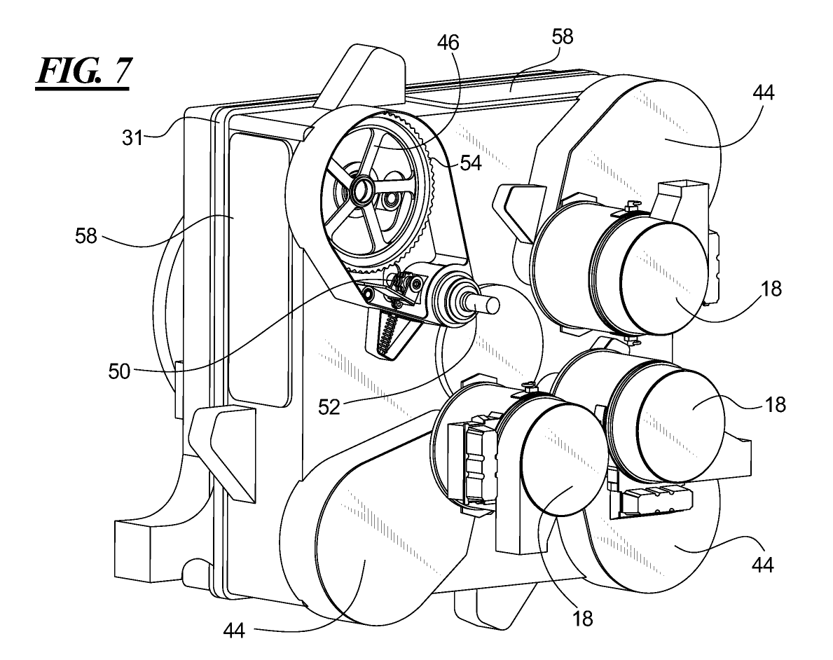

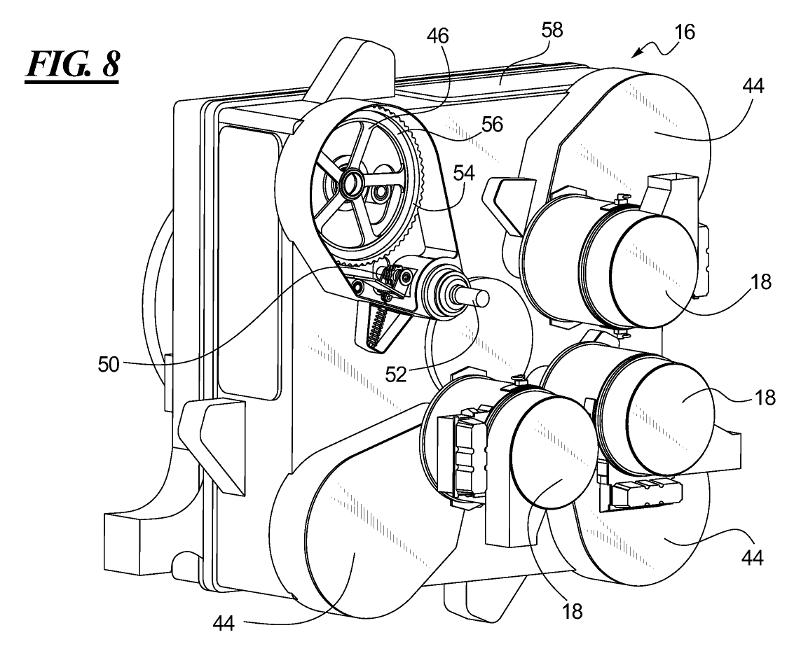

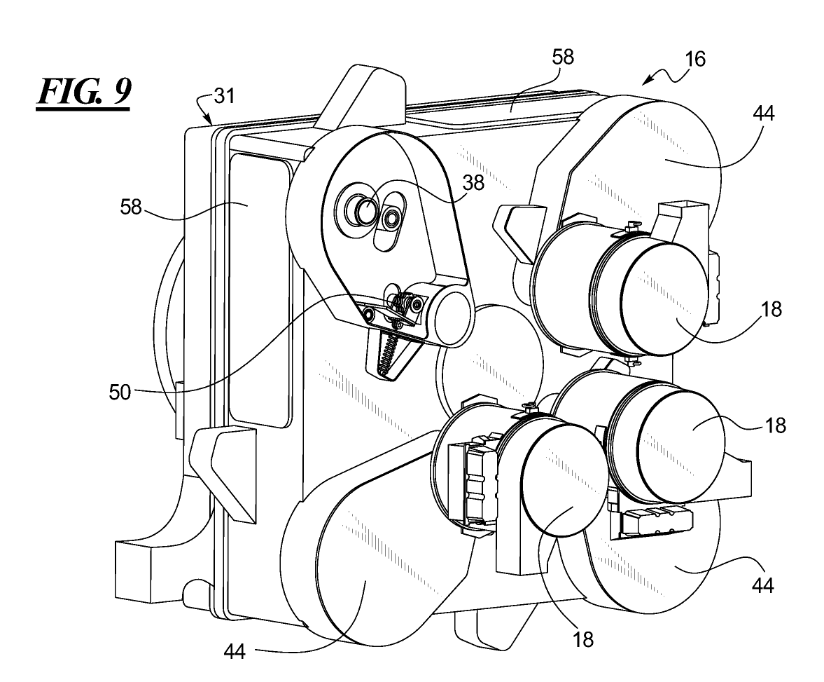

Subsequent to removing the cover 44, as shown in FIG. 7, the high speed chain 48 may be removed by pulling the chain out from the second stage driven sprocket 50 and the second stage drive sprocket 46. The high speed chain 48 may be removed (e.g., by disconnecting one of its links) either when the high speed chain itself needs to be serviced or when any of the second stage drive sprocket 46 or the second stage driven sprocket 50 need servicing. The cover 44 may facilitate removing the high speed chain 48 without removing the generators 18. Next, as shown in FIG. 8, if the second stage drive sprocket 46 needs to be serviced, then the segments 54 of the second stage drive sprockets may be removed individually or if a wheel portion 56 of the second stage drive sprocket is to be serviced, then as shown in FIG. 9, the wheel portion 56 may be dismantled from the intermediate speed shaft 38. To service the second stage driven sprocket 50 or the high speed shaft 52, each of those components may be removed and/or dismantled subsequent to removing the high speed chain 48.

Relatedly, as shown in FIG. 10, one or more of the plurality of chain strands 34 of the first stage chain drive 28 may be serviced by opening one or both covers 58 and then pulling apart the one of the plurality of chain strands that needs to be serviced. As with the high speed chain 48, the plurality of chain strands 34 may be removed by disconnecting one of the links of the respective chain strand to be serviced and pulling away from the first stage drive sprocket 32 and the first stage driven sprockets 36. Similarly, although not shown, the first stage drive sprocket 32, any of the first stage driven sprockets 36 and/or any of the intermediate speed shafts 38 may be serviced by removing those components after dismantling the associated one of the plurality of chain strands 34 in a manner described above.

Upon removing the components from the first stage chain drive 28 or the second stage chain drive 30 from the drive train housing 31 that needs servicing, those relatively lightweight components (as compared to traditional gearbox and direct drive components) may be easily lowered from the tower section 4 of the wind turbine 2 by an onboard hoist and replaced with new components. The replaced components may then be hoisted back up to the nacelle 14 and installed back into position.

Notwithstanding the fact that in the present embodiment, one of the first stage chain drive 28 and one of the second stage chain drive 30 have been described above, it will be understood that this is merely exemplary. In other embodiments, more than one of each of the first and the second stage chain drives 28 and 30, respectively, may be employed, depending upon the torque reduction and the speed increase desired. In at least some other embodiments, only a single stage of a chain drive may be employed, such that the one stage of the chain drive may drive the generators directly.

### INDUSTRIAL APPLICABILITY

In general, the present disclosure sets forth a distributed balanced chain drive train that employs first and second stages of a chain drive to reduce torque and increase rotor speed from the main shaft to the generators. The first stage may include a firs stage drive sprocket, which may engage a plurality of chain strands or low speed chains, each of which may drive a smaller first stage or low speed driven sprocket connected to an intermediate speed shaft. Each of the intermediate speed shafts may in turn be connected to a second stage chain drive and, particularly, a second stage drive sprocket driving a high speed chain trained around a second stage driven sprocket, which in turn may drive a high speed shaft to drive the generators. Because of the difference in the number of sprocket teeth between the first stage drive sprocket and the smaller first stage driven, second stage drive and the second stage driven sprockets, each stage achieves a speed increase and torque decrease. The split of torque into four separate paths culminating in four separate generators further helps to reduce the torque. The loads on the main shaft and main bearings are reduced through symmetrically arranging the first stage chains and driven sprockets around the main shaft so that the chain tension forces somewhat cancel out one another.

Such a distributed chain drive train advantageously provides first and second stage chain drive trains that are resilient to deflections. The sprockets and chain drives are resilient to misalignment of the driver and driven sprockets. Any misalignments may be tolerated in part by the flexibility of the chains, and do not significantly reduce the overall lifespan of the sprockets and chains. Furthermore, light weight and low cost generators (roughly one fifth of the size of direct drive generators) may be employed. Also, the serviceability of the chain drive train in comparison with conventional drive trains may be significantly improved, given especially the smaller and more serviceable parts of the chain drive train that may be serviced easily with an on board hoist without requiring any special hauling equipment to remove heavy equipment from the wind turbine.

While only certain embodiments have been set forth, alternatives and modifications will be apparent from the above description to those skilled in the art. These and other alternatives are considered equivalents and within the spirit and scope of this disclosure and the appended claims.

We claim:

1. A wind turbine, comprising:
a hub;
a plurality of blades radially extending from the hub;
a main shaft rotating with the hub;
a drive sprocket mounted onto the main shaft;
a plurality of driven sprockets symmetrically arranged around the main shaft;
at least one drive strand connecting the drive sprocket to the plurality of driven sprockets; and
at least one generator operatively connected to and driven by the plurality of driven sprockets.

2. The wind turbine of claim 1, wherein the drive sprocket comprises a plurality of drive sprocket segments with at least one drive strand trained around each of the drive sprocket segments and driving one of the plurality of driven sprockets.

3. The wind turbine of claim 1, wherein the plurality of driven sprockets comprises four first stage driven sprockets and the wind turbine further includes four second stage drive sprockets, each of the four first stage driven sprockets connected to one of the four second stage drive sprockets.

4. The wind turbine of claim 3, wherein the at least one generator comprises four generators, each of the four generators being driven by one of the second stage drive sprockets through a second stage drive strand.

5. The wind turbine of claim 4, wherein each of the second stage drive strand is a chain strand.

6. The wind turbine of claim 4, wherein each of the second stage drive strand is a belt strand.

7. The wind turbine of claim 3, wherein each of the first stage driven sprockets is connected one of the second stage drive sprockets through an intermediate speed shaft.

8. The wind turbine of claim 3, wherein the wind turbine further comprises four second stage driven sprockets, each of the second stage drive sprockets connected to one of the four second stage driven sprockets.

9. A wind turbine, comprising:
a hub;
a plurality of blades radially extending from the hub;
a main shaft rotating with the hub;
a first stage drive train having a first stage drive sprocket operatively connected to the main shaft, at least one first stage driven sprocket, and at least one first stage chain strand trained around the first stage drive sprocket and the at least one first stage driven sprocket, the first stage drive train increasing speed relative to the main shaft, while reducing torque; and
a second stage drive train operatively connected to the first stage drive train, the second stage drive train having at least one second stage drive sprocket operatively connected to the at least one first stage driven sprocket, the second stage drive train further having at least one second stage driven sprocket, and at least one second stage chain strand trained around the at least one second stage drive sprocket and the at least one second stage driven sprocket, the second stage drive train increasing speed relative to the first stage drive train, while further reducing torque.

10. The wind turbine of claim 9, wherein at least one of the first stage drive train and the second stage drive train is a chain drive.

11. The wind turbine of claim 9, wherein at least one of the first stage drive train and the second stage drive train is a belt drive.

12. The wind turbine of claim 9, wherein the first stage drive sprocket includes a plurality of drive sprocket segments, and each of the plurality of drive sprocket segments drives one of the at least one first stage driven sprocket through one of the at least one first stage strand.

13. The wind turbine of claim 12, wherein the at least one first stage chain strand comprises four low speed chain strands and the at least one first stage driven sprocket comprises four first stage driven sprockets, each of the four low speed chain strands trained around one of the plurality of drive sprocket segments and driving one of the four first stage driven sprockets.

14. The wind turbine of claim 9, wherein the at least one second stage drive sprocket comprises four second stage drive sprockets and the at least one second stage driven sprocket comprises four second stage driven sprockets.

15. The wind turbine of claim 14, wherein the at least one second stage chain strand comprises four high speed chain strands, each of the four high speed chain strands trained around one of the second stage drive sprockets and driving one of the four second stage driven sprockets.

16. The wind turbine of claim 9, wherein the first stage drive train is connected to the second stage drive train through a plurality of intermediate shafts.

17. The wind turbine of claim 9, further including more than two stages of drive trains.

18. A wind turbine, comprising:
a hub;
a plurality of blades radially extending from the hub;
a main shaft rotating with the hub;
a drive sprocket mounted onto the main shaft and having a plurality of drive sprocket segments;
a plurality of driven sprockets;
a plurality of drive strands trained around and connecting the drive sprocket segments to the plurality of driven sprockets such that the torque of the drive sprocket is split amongst the plurality of drive strands and reduced; and
at least one generator operatively connected to and driven by the plurality of driven sprockets.

19. The wind turbine of claim 18, wherein the at least one generator is a plurality of generators, and each of the plurality of driven sprockets operatively drives a single generator.

20. The wind turbine of claim 18, wherein the plurality of driven sprockets comprises four or fewer driven sprockets.
